(19) United States
(12) Patent Application Publication
(10) Pub. No.: US 2024/0419195 A1
(43) Pub. Date: Dec. 19, 2024

(54) SYSTEMS AND METHODS FOR PROVIDING HEAT TO ENCLOSURES DURING SEALING PROCESSES

(71) Applicant: Aeroseal LLC, Miamisburg, OH (US)

(72) Inventors: Mark Modera, Piedmont, CA (US); Justin McClain, Dayton, OH (US); Avery Goldinger, Dayton, OH (US); Joel Wesley Summerfield, Dayton, OH (US); Michael Joesph Coyle, Tipp City, OH (US)

(21) Appl. No.: 18/821,250

(22) Filed: Aug. 30, 2024

Related U.S. Application Data
(63) Continuation-in-part of application No. 18/594,817, filed on Mar. 4, 2024.
Application No. 18/594,817 is a continuation of application No. 17/230,728, filed on Apr. 14, 2021, now Pat. No. 11,921,524.
(60) Provisional application No. 63/009,745, filed on Apr. 14, 2020.

(51) Int. Cl. G05D 11/13; B05B 12/12; G05B 15/02

(52) U.S. Cl. CPC G05D 11/138; B05B 12/12; G05B 15/02

(57) ABSTRACT

Embodiments of the present disclosure provide an aerosolized sealant particle injection system. The system includes sealant injection stations and a combustion-type heater to generate heat for heating an enclosure. Each of the sealant injection stations includes a supply reservoir to store a fluid and a sealant, and a sprayer assembly to aerosolize the fluid and the sealant within the enclosure. The enclosure includes at least one leak opening. During operation, the heating of the enclosure causes solidification of aerosolized particles of the fluid and the sealant in the enclosure to seal the at least one leak opening.

### CROSS-REFERENCE

The present application is a continuation-in-part of U.S. patent application Ser. No. 18/594,817, titled “Autonomous Concentration Control Systems and Method of Controlling Concentration of a Gas or Particle Mixture,” which is a continuation of U.S. patent application Ser. No. 17/230,728, now U.S. Pat. No. 11,921,524, titled “Autonomous Concentration Control Systems and Method of Controlling Concentration of a Gas or Particle Mixture,” which claims the benefit of and priority to U.S. Provisional Patent Application No. 63/009,745, tided “Autonomous Concentration Control System,” the details of all of which are incorporated by reference herein.

### TECHNICAL FIELD

The present specification generally relates to autonomous concentration control systems and methods of providing heat to enclosures using combustion-type heaters during sealing processes.

### BACKGROUND

Building enclosures often have or form leaks through which conditioned air may exit the enclosure to an unconditioned space (e.g., the environment). Such leaks may reduce energy efficiency of conditioning systems and may reduce indoor air quality (IAQ).

Various methods have been tried for locating and sealing air leakage paths in enclosures. For example, a pressure differential and a fog of aerosolized sealant composition may be utilized to deposit sealant particles at leak sites to seal the leak sites.

While using the fog of aerosolized sealant provides significant advantages over methods that rely on discovering leaks and manually sealing them with caulk, foam or other type of barrier, however, the fog of aerosolized sealant fails to effectively seal the leak sites. Therefore, there remains a need for improved methods of identifying and automatically sealing leak sites causing air leaks in, for example, seams, joints, ceiling, and wall perforations, to improve air barrier of enclosures, such as homes, offices, larger buildings, and other structures. Further, there is a need for automatically controlling a mixture concentration of aerosolized sealant in order to control properties of the mixture to effectively seal the leak sites. The principles described herein may be used to overcome challenges arising due to inaccessibility of leak sites at, for example, boilers, hidden ducts, pipelines, crawl spaces, attics, and other hard to reach areas. Accordingly, a need exists for an autonomous concentration control system and method for effectively enclosing all possible leak sites during the sealing process.

### SUMMARY

In one embodiment, an aerosolized sealant particle injection system is provided for effectively sealing leak sites within an enclosure during a sealing process by providing heat using combustion-type heaters. The aerosolized sealant particle injection system includes one or more sealant injection stations and a combustion-type heater to generate heat for heating the enclosure. Further, each of the one or more sealant injection stations include a supply reservoir to store a fluid and a sealant, and a sprayer assembly to aerosolize the fluid and the sealant within the enclosure. The enclosure may include at least one leak opening. Further, during an operation, the heating of the enclosure causes solidification of aerosolized particles of the fluid and the sealant in the enclosure to seal the at least one leak opening.

In another embodiment, a method of providing heat to an enclosure for sealing the enclosure using an aerosolized sealant particle injection system is provided. The aerosolized sealant particle injection system comprises one or more sealant injection stations and a combustion-type heater to generate heat for heating the enclosure, the one or more sealant injection stations comprising a supply reservoir to store a fluid and a sealant, and a sprayer assembly. The method includes aerosolizing, using the sprayer assembly, the fluid and the sealant within the enclosure. The enclosure comprises at least one leak opening. The method further includes generating heat for the enclosure from the combustion-type heater. The method further includes heating the enclosure using the heat. The heating causes solidification of aerosolized particles of the fluid and the sealant in the enclosure to seal the at least one leak opening.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments may be understood when read in conjunction with the following drawings, where like structure is indicated with like reference numerals and in which:

FIG. 1A is a perspective view of an enclosure including an aerosolized sealant particle injection system, according to one or more example embodiments of the present disclosure;

FIG. 1B illustrates a detailed view of a leak site of the enclosure shown in the FIG. 1A, according to one or more example embodiments of the present disclosure;

FIG. 1C illustrates a nozzle apparatus and a compressor, according to one or more example embodiments of the present disclosure;

FIG. 2 illustrates a sealant injection station of the aerosolized sealant particle projection system of FIG. 1, according to one or more example embodiments of the present disclosure;

FIG. 3 is a schematic illustration of the aerosolized sealant particle injection system of FIG. 1A, according to one or more example embodiments of the present disclosure;

FIG. 4 illustrates a combustion-type heater and an air flow conduit for supplying heated air to the enclosure of FIG. 1, according to one or more example embodiments of the present disclosure;

FIG. 5 illustrates an example combustion-type heater for use with the aerosolized sealant particle injection system, according to one or more example embodiments of the present disclosure;

FIG. 6 illustrates a part of a heater core for use with the combustion-type heater of FIG. 5, according to one or more example embodiments of the present disclosure;

FIG. 7 illustrates an example combustion-type heater, according to one or more example embodiments of the present disclosure;

FIG. 8 illustrates an example combustion-type heater, according to one or more example embodiments of the present disclosure; and

FIG. 9 illustrates an example combustion-type heater, according to one or more example embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure. Some embodiments of the present disclosure will now be described more fully hereinafter with reference to the accompanying drawings, in which some, but not all, embodiments of the disclosure are shown.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

Embodiments described herein are generally directed to methods and systems for providing heat to an enclosure for sealing the enclosure using an aerosolized sealant particle injection system. The aerosolized sealant particle injection system comprises one or more sealant injection stations and a combustion-type heater to generate heat for heating the enclosure, the one or more sealant injection stations comprising a supply reservoir to store a fluid and a sealant, and a sprayer assembly. The method includes aerosolizing, using the sprayer assembly, the fluid and the sealant within the enclosure. The enclosure comprises at least one leak opening. The method includes generating heat for the enclosure from the combustion-type heater. The method includes heating the enclosure using the heat, wherein the heating causes solidification of aerosolized particles of the fluid and the sealant in the enclosure to seal the at least one leak opening.

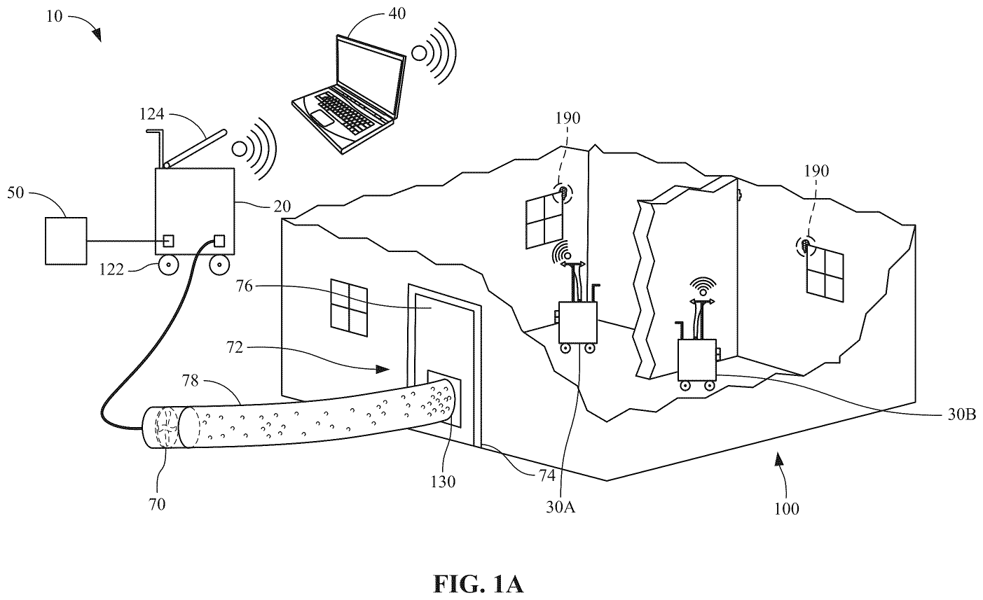

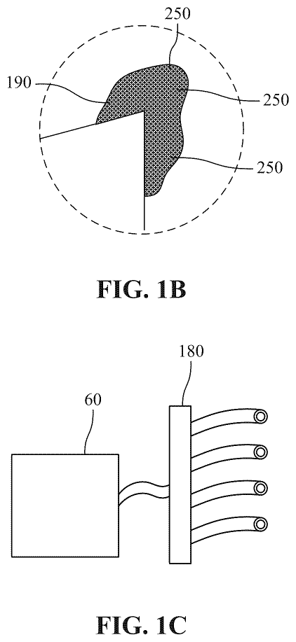

FIG. 1A illustrates a perspective view of an enclosure including an aerosolized sealant particle injection system 10 (hereinafter referred as system 10), according to one or more example embodiments of the present disclosure, the system 10 comprises one or more sealant injection stations 30. In an example, the system 10 may include a main control unit 20, and a user interface device 40, for example a mobile device such as a laptop or tablet. The system 10 may be powered by an optional generator 50 or may be powered from an in-house source, for example a dryer 240V outlet.

The system 10 may be used to air seal an enclosure 100, such as a house, apartment, or other interior space in which a pressure differential may be maintained. As explained in further detail below, system 10 may be utilized in other applications as well.

In an embodiment, the one or more sealant injection stations comprises a supply reservoir to store a fluid and a sealant. In an embodiment, in the supply reservoir, the fluid and the sealant may be kept in two different compartments. In another embodiment, in the supply reservoir, a mixer of the fluid and the sealant may be kept in together.

The one or more sealant injection stations 30 comprises a sprayer assembly to aerosolize the fluid and the sealant within an enclosure 100. The enclosure 100 comprises at least one leak opening. In an example the one or more sealant injection station 30 may comprise a sprayer assembly to aerosolize the mixer of fluid and the sealant in the enclosure.

In an embodiment, the main control unit 20 includes a housing 120 to hold various components that may supply power to other system components and send and receive signals for controlling operations and reading environmental conditions. In one embodiment, the housing includes one or more wheels 122 and a handle 124 for mobility. The housing 120 may include a hinged or removable lid 126 to protect components during transport. The design and layout of the housing 120 of the main control unit 20 may be any configuration that accomplishes the purposes described herein. In an embodiment, the main control unit 20 may be operated outside of the enclosure 100 to be sealed, while each of the one or more sealing injection station 30 is operated inside the enclosure 100.

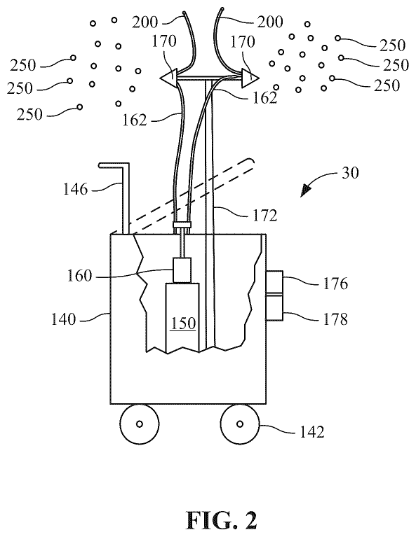

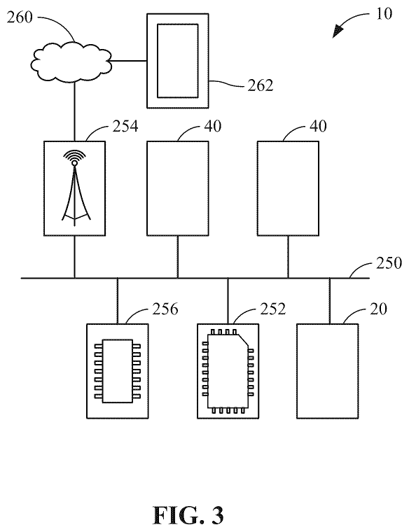

It may be noted, FIG. 1A, FIG. 1B, FIG. 1C, FIG. 2 and FIG. 3 briefly describe the enclosure 100 in which the aerosolized sealant particle injection system 10 is implemented and operations of the aerosolized sealant particle injection system 10 in different stages, such as pre-sealing stage, post-sealing stage etc. Subsequently, for clarity and brevity, the FIG. 1A. FIG. 1B, FIG. 1C, FIG. 2 and FIG. 3 are described based on a corresponding stage in which the aerosolized sealant particle injection system 10 operates. Subsequently, the FIG. 1B, FIG. 2 and FIG. 3 are described below, such as after the preparation of the enclosure 100 and the sealing process, such as in the post-sealing stage. Subsequently, the FIG. 1B is described in the sealing stage later in the stage.

Referring to FIG. 1C, there is shown a nozzle apparatus 180 and a compressor 60, according to one or more example embodiments of the present disclosure. A source of compressed air, such as the compressor 60, supplies compressed air to system 10 that is used to aerosolize sealant material as described in greater detail below. It is envisioned that other methods, for example, airless nozzles or portable compressors, to aerosolize sealant material may be utilized and may lie within the scope of the present disclosure.

The system 10 uses a fan 70 to create a pressure differential in an enclosure 100 as will be explained in greater detail below. In an embodiment, the pressure differential is measured with a manometer housed in a fan control unit. In another embodiment, fan 70 is selected to provide sufficient air flow while minimizing or preventing back flow of sealant material being supplied by the system 10. The system 10 may include one or more combustion-type heaters 130 for providing heating air flowing into the enclosure 100.

The system 10 includes wireless capability to send and receive information between the main control unit 20 and the user interface device 40. The system 10 is also capable of wirelessly sending and receiving information between the main control unit 20 and the one or more sealant injection stations 30. In some embodiments, the system 10 has mesh network capability so that signals may also be sent between one or more sealant injection stations 30. Other features included in system 10 are GSM and GPS capability.

FIG. 2 illustrates a sealant injection station of the aerosolized sealant particle projection system of FIG. 1, according to one or more example embodiments of the present disclosure. In an embodiment, each of the one or more sealing injection station 30 may comprise a rechargeable, battery-operated unit that is enabled to provide aerosolized sealant to a local region of the enclosure 100. The sealant injection stations 30 includes one or more wheels 142, handle 144 and hinged or removable lid 146 for easy mobility and access. The housing 140 is configured to hold a supply reservoir 150 of sealant material in liquid, non-aerosolized form. The sealant injection stations 30 is equipped with a delivery system 160 to transfer the sealant and fluid to the sprayer assembly. In an embodiment, the delivery system is able to deliver the sealant material to one or more or nozzles 170 carried on the housing 140 where the liquid sealant material (i.e., sealant solids carried in water or other solvent) interfaces with compressed air from compressor 60 and aerosolizes to become a fog of sealant material.

In one embodiment, the sealant injection stations 30 may have two nozzles 170, each fed by the delivery system 160, and each with a discrete line of compressed air. Air from the compressor 60 may be directed to the nozzle apparatus 180 and from there to a designated nozzle 170 (as shown in FIG. 1C) of a sprayer assembly. The nozzle design cooperates with the compressed air to provide aerosolized, sealant particles (having excess liquid such as water or other solvent removed). In one embodiment, each of the nozzles 170 is mounted on an adjustable stand 172 such that the height and direction of the nozzles 170 may be arranged to provide optimal sealant coverage in the enclosure 100.

During operation, a pressure differential exists between the interior and exterior of the enclosure 100, such that the particles of aerosolized sealant material are carried by air moving toward leak sites 190 in the enclosure 100. Sealant particles remain sufficiently tacky to adhere to the edges of the leaks and to each other to form a seal (air barrier) at the leak sites 190. In one embodiment, the tackiness of the sealant particles diminishes over time such that particles coalesce to form a seal at a leak site, but the sealant is not sticky when touched.

The sealant injection stations 30 includes a temperature sensor 176 and a humidity sensor 178 to read temperature and humidity (absolute or relative) in the local region around the sealant injection stations 30. The humidity sensor 178 is used to monitor a concentration level of water in the environment. Other factors indicative of concentration levels may be monitored, such as dew point, wet-bulb temperature and various chemical substances delivered to the air, for example, using a chemical sensor. During operation, the parameters determine the concentration level of moisture (water) or other substances in the air in the local region around the sealant injection stations 30. Because the sealant material is initially in liquid form and is dried as it is aerosolized, the excess moisture is imparted to the air surrounding the sealant injection stations 30. Thus, during operation of system 10, one result of sealant material being distributed to the enclosure 100, is an increase in humidity, as sensed by sensor 178. The delivery system 160 is controlled to operate responsive to the reading of sensor 178. If a humidity value reaches a threshold value (e.g., range or point values), the delivery system 160 will automatically shut off. By sensing the change in humidity and controlling the delivery system 160, the concentration of sealant material in the enclosure 100 may be controlled. Thus, excess sealant material, as determined by local humidity conditions, is prevented from depositing in the enclosure 100. The one or more sealant injection stations 30 control of sealant material allows for optimizing the sealant injection stations 30 rates, the time and sealant required for air sealing an enclosure 100, and control of the drying process for the sealant particles while minimizing sealant wastage and unwanted sealant deposition.

The system 10 may include the one or more sealant injection stations 30, for example, a first sealant injection station 30a, a second sealant injection station 30b positioned in spaced relationship around the enclosure 100. In an example, it is envisioned that having one sealing station for every 500 square feet of the enclosure to seal will give optimal results. Each sealant injection stations 30 senses the local temperature and relative humidity. For example, if the local conditions at a first sealant injection stations 30a reach the threshold value, the pump assembly will shut off and no further sealant material will be discharged. Each of the one or more sealant injection stations 30 such as, the first sealant injection stations 30a, and the second sealant injection stations 30b, may operate independently of the other. Thus, the second sealant injection stations 30b, remote from the first sealant injection stations 30a, may continue to operate according to the local conditions sensed by its relative humidity sensor.

Each of the one or more sealant injection stations 30 are connected via the mesh network and send information to the main control unit 20, which communicates with the user interface device 40 so that operation of the system 10 and each of the one or more sealant injection stations 30 may be monitored and controlled.

FIG. 3 illustrates a schematic diagram of the aerosolized sealant particle injection system 10, according to one or more example embodiments of the present disclosure. The system 10 includes a communication path 250, a processor 252, a memory module 256, sealant injection stations 30, and the user input device 40 that may be the computer. The sealant injection stations 30 may include temperature sensor 176 and humidity sensors 178. The system 10 may further include the main control unit 20 and a network interface hardware 254.

The system 10 includes the communication path 250 that provides data interconnectivity between various modules disposed within the system 10. Specifically, each of the modules may operate as a node that may send and/or receive data. In some embodiments, the communication path 250 includes a conductive material that permits the transmission of electrical data signals to processors, memories, sensors, and actuators throughout the control system 10. In some embodiments, the communication path 250 may be wireless and/or an optical waveguide. Components that are communicatively coupled may include components capable of exchanging data signals with one another such as, for example, electrical signals via conductive medium, electromagnetic signals via air, optical signals via optical waveguides, and the like. The system 10 includes the processor 252 communicatively coupled with the memory module 256 over the communication path 250. The processor 252 may include any device capable of executing machine-readable instructions stored on a non-transitory computer-readable medium. The processor 252 may include one or more processors. For example, each of the sealant injection stations 30 and the main control unit 20 may include processors 252 and memory modules 256. Accordingly, each processor 252 may include a controller, an integrated circuit, a microchip, a computer, and/or any other computing device.

The memory module 256 is communicatively coupled to the processor 252 over the communication path 250. The memory module 256 may be configured as volatile and/or nonvolatile memory and, as such, may include random access memory (including SRAM, DRAM, and/or other types of RAMs), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the any of the sealant injection stations 30 and main control unit 20 and/or external to the sealant injection stations 30 and main control unit 20. The memory module 256 may be configured to store one or more pieces of logic, as described herein. The memory module 256 may include one or more memory modules. The embodiments described herein may utilize a distributed computing arrangement to perform any portion of the logic described herein.

Embodiments of the present disclosure include logic stored on the memory module 256 that includes machine-readable instructions and/or an algorithm written in any programming language of any generation (e.g., 1GL, 2GL, 3GL, 4GL, and/or 5GL) such as, machine language that may be directly executed by the processor 204, assembly language, object-oriented programming (OOP), scripting languages, microcode, etc., that may be compiled or assembled into machine readable instructions and stored on a machine readable medium. Similarly, the logic and/or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, and/or as a combination of hardware and software components.

The system 10 includes the user input device 40 coupled to the communication path 250 such that the communication path 250 communicatively couples the user input device 40 to other modules of the system 10. The user input device 40 may be controlled manually. In some embodiments, there may be multiple user input devices. The user input device 40 may be any device capable of transforming mechanical, optical, or electrical signals into a data signal capable of being transmitted with the communication path 250. Specifically, the user input device 40 may include any number of movable objects that transform physical motion into a data signal that may be transmitted over the communication path 250. The user input device 40 may allow a user to control operation of the control system 10.

In some embodiments, the control system 10 further includes network interface hardware 254 for communicatively coupling the control system 10 with a network 260. The network interface hardware 254 may be communicatively coupled to the communication path 250 and may be any device capable of transmitting and/or receiving data via the network 260. Accordingly, the network interface hardware 254 may include a communication transceiver for sending and/or receiving any wired or wireless communication. For example, the network interface hardware 254 may include an antenna, a modem, LAN port, Wi-Fi card, WiMax card, mobile communications hardware, near-field communication hardware, satellite communication hardware and/or any wired or wireless hardware for communicating with other networks and/or devices.

The control system 10 may communicate, through the network interface hardware 254, with the network 260 to communicatively couple the control system 10 with the mobile device 262. In one embodiment, the network 260 is a personal area network that utilizes Bluetooth technology to communicatively couple the control system 10 and the mobile device 262. In other embodiments, the network 260 may include one or more computer networks (e.g., a personal area network, a local area network, or a wide area network), cellular networks, satellite networks and/or a global positioning system and combinations thereof. Accordingly, the control system 10 may be communicatively coupled to the network 260 via wires, via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

In some embodiments, the mobile device 262 may be included as a user input device. The mobile device 262 may include a processor and a memory module. The processor may execute logic to communicate with the control system 10 in order to facilitate sending instructions to the control system 10 from the mobile device 262 to control the control system 10. The mobile device 262 may be configured with wired and/or wireless communication functionality for communicating with the control system 10. In embodiments described herein, the mobile device 262 may include mobile phones, smartphones, personal digital assistants, dedicated mobile media players, mobile personal computers, laptop computers, and/or any other mobile devices capable of being communicatively coupled with the control system 10. It is noted, that in this embodiment, the control system 10 may communicate with the mobile device 262 even while the mobile device 262 is remote from the sealant injection stations 30 and main control unit 20. In this way, the control system 10 may be controlled with the mobile device 262 remotely.

A process for setting up system 10 and performing a scaling event is now described.

### A. Preparing the Enclosure

Referring to FIG. 1A, any intentional openings in the enclosure 100 should be sealed/masked prior to system start up. Additionally, any visible unintentional openings/holes greater than about ⅝″ should be manually sealed with caulk or other scaling material. The system 10 may be used to seal any enclosure 100 but optimal results in sealing homes under construction may be achieved either before drywall phase (rough in), after drywall phase, or finished houses. In operation, horizontal surfaces with finished surfaces should be covered. A main opening to the enclosure 100, such as a doorway, is fitted with a blower door assembly 72 including a frame 74 and cloth 76. Although referred to as a blower door assembly 72, in one embodiment, a typical blower door assembly is modified in that the fan 70 is not mounted in the blower door assembly 72 but is located some distance away. In one embodiment an air flow conduit 78 extends from the fan 70 to the blower door assembly 72 to direct the flow of air from the fan to the enclosure 100 where the air is optionally heated by one or more combustion-type heaters 130 that may be mounted in a frame to fit the opening in the blower door cloth. Separating the fan 70 some distance from the enclosure is intended to minimize the back flow of sealant material. The manometer is arranged to enable reading the pressure differential from outside and inside the enclosure. In one embodiment, if used, the combustion-type heater(s) 130 may be powered through connecting with the main control unit. In one embodiment, the one or more combustion-type heaters 130 may be controlled with a heater selection algorithm to provide heater selection and control.

The heater selection algorithm may allow addition of heat to a system to increase dispensing of sealant material without driving the relative humidity too low and risking the deposition of overly dry sealant material. The algorithm iteratively examines a level of added heat and calculates the quantity of sealant material that could be dispensed based on a target humidity, and the temperature, relative humidity, and flow rate of fan air entering the enclosure 100. If a certain level of added heat would allow all sealant stations to begin ejecting sealant, then that heat level is chosen. Otherwise, a lower level of added heat is examined in turn until a working level is discovered or a zero added heat is reached.

### B. Use of Combustion-Type Heaters

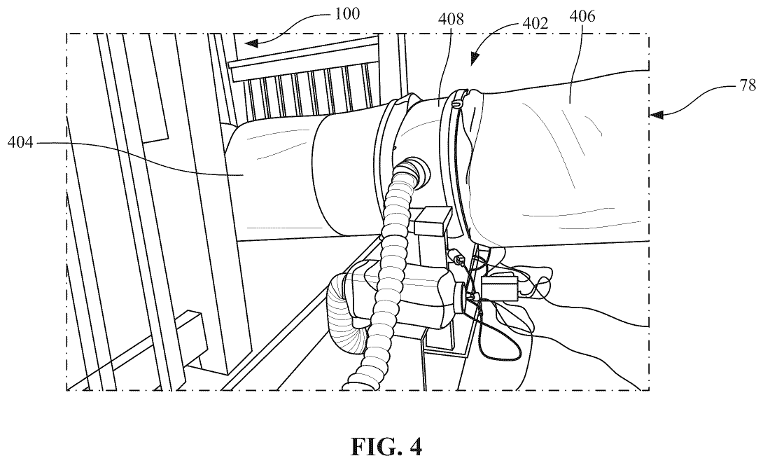

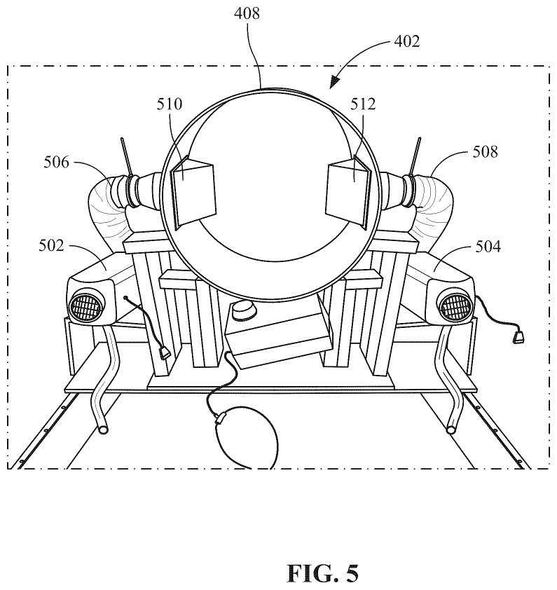

FIG. 4 illustrates a combustion-type heater 402 and an air flow conduit 78 for supplying heated air to the enclosure 100 of FIG. 1, according to one or more example embodiments of the present disclosure. In an embodiment, to break dependence on large, centralized generators for providing power for heating. The combustion-type heater 402 to generate heat for heating the enclosure 100, such that during an operation, the heating of the enclosure causes solidification of aerosolized particles of the fluid and the sealant in the enclosure to seal the at least one leak opening. In an embodiment using the combustion-type heater 402, the system 10 ensures efficient heat generation through fuel combustion, which is important for the rapid and effective solidification for the sealant particles.

Moreover, the combustion-type heater 402 comprises an air flow conduit 78 to supply heated air to the enclosure, and one or more heater cores configured to provide the heated air to the air flow conduit. In an embodiment, the combustion-type heater 402 may include an air flow conduit 78, comprising a part 404, a part 406 and a part 408. Further the combustion-type heater 402 may include one or more heater cores. The parts 404, 406 and 408 of the air flow conduit 78 function as a pathway through which the heated air is delivered to the enclosure 100. In another embodiment, one or more heater cores generate the heated air that enters the air flow conduit 78. By burning the fuel, the one or more heater cores produce heat, which is then transferred to air flowing through the air flow conduit 78 to heat the flowing air. This design ensures that the air entering the enclosure 100 is consistently warm, aiding in the solidification of aerosolized sealant particles in the enclosure 100. For instance, the heated air circulates within the enclosure 100, it then raises the internal temperature of the enclosure 100, promoting the solidification of the aerosolized fluid and the sealant particles.

In this regard, the combustion-type heater 402 may be considered “non-electric” in the sense that heat generation is achieved using combustion as opposed to electric heat generation, such as resistance heating. The combustion-type heater 402 provides a reliable and efficient means of generating heat, making it suitable for use in a wide range of climates and conditions. By leveraging combustion for heat generation, the system 10 reduces its reliance on electric heat sources, which may be particularly advantageous in scenarios where electric power is scarce or expensive.

In an embodiment, the part 408 of the air flow conduit 78 of the combustion-type heater 402 is located between a fan 70 and a tubing that extends toward the enclosure 100. In an example, the combustion-type heater 402 is positioned between the enclosure 100 being serviced and the fan 70 (FIG. 1A), between two sections or parts 404 and 406 of the air flow conduit 78 and is used to increase pressure within the enclosure 100, as discussed above. The combustion-type heater 402 is positioned between the enclosure 100 being serviced and the fan 70 used for building the pressure. This placement ensures that the heated air is directed efficiently into the enclosure 100, enhancing the effectiveness of the sealing process. By positioning the combustion-type heater 402 in this manner, it is possible to maximize the thermal energy transfer to the air entering the enclosure 100, thereby optimizing the heating performance.

In another embodiment, the combustion-type heater 402 may be positioned next to the fan 70 and then connected to tubing that extends toward the enclosure. For instance, the configuration allows for flexibility in the setup and may be advantageous in scenarios, where space constraints or specific operational requirement dictate a different arrangement. By positioning the combustion-type heater 402 downstream of the fan 70, the system 100 may ensure that the heated air is evenly distributed throughout the enclosure, maintaining a consistent temperature profile.

FIG. 5 illustrates an example combustion-type heater 402 for use with the aerosolized sealant particle injection system 10, according to one or more example embodiments of the present disclosure. In one embodiment, the combustion-type heater 402 includes the part 408 (for example, implemented as a section of a metal tube) of the air flow conduit 78 and one or more heater cores, such as a first heater core 502, and a second heater core 504. The first heater core 502 and the second heater core 504 are located at opposite ends of the air flow conduit 78. The one or more heater cores are configured to provide heated air inside the air flow conduit 78, which receives pressurized supply air from the fan 70.

In an embodiment, each of the one or more heater cores are arranged outside the air flow conduit 78, such that the one or more heater cores are in fluid communication with an interior of the air flow conduit 78 using an air duct to provide the heated air. In an example, these duct serves as channels that convey the heated air generated by the one or more heater cores directly into the air flow conduit 78. The air ducts ensure that the heated air from the each of the one or more heater cores is efficiently transferred into the air flow conduit 78. The elevated temperature with the enclosure 100, facilitated by the heated air, ensures that the sealant particles solidify effectively, sealing any leak opening present. The combustion air intake and the combustion exhaust are isolated from the heated air. In an example, the first heater core 502 may be fluidly connected to air duct 506, similarly, the second heater core 504 may be fluidly connected to air duct 508. In another embodiment, the air ducts 506 and 508 are connected to a vent located inside the air flow conduit 78, such as in the part 408. In an example, the vent may be heat resistant flex tubing. For example, a first vent 510 may extend from the first heater core 502 to the air flow conduit 78. Similarly, a second vent 512 may extend from the second heater core 504 to the air flow conduit 78. The first vent 510 and the second vent 512 may be configured to direct the heated air downstream, such as towards the part 408 of the air flow conduit 78, which directs the heated air to the part 404 and further to the enclosure 100. In an embodiment, the air flow conduit 78 is fluidly connected to a tubing that extends towards the enclosure 100. In another embodiment, the tubing is connected to a fan 70 to provide feed air. The one or more heater cores, such as the heater cores 502 and 504 are operable to heat the feed air to produce the heated air. In an example, this design ensures a continuous and controlled pathway for the heated air to travel from the combustion-type heater 402 to the enclosure 100. In an example, the tubing serves as an extension of the air flow conduit 78, guiding the heated air precisely to where it is needed within the enclosure 100. This setup is particularly useful in applications where the combustion-type heater 402 cannot be placed directly adjacent to the enclosure 100, or where the heated air needs to be distributed evenly throughout a large space.

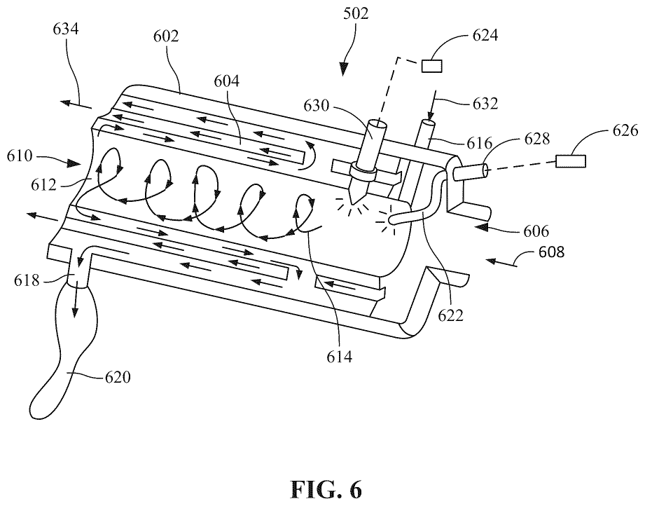

FIG. 6 illustrates a part of a heater core, say the first heater core 502 for use with the combustion-type heater 402, according to one or more example embodiments of the present disclosure. In an embodiment, each of the one or more heater cores, such as the first heater core 502 may include an outer housing 602 having a first passageway 604 for directing the heated air into the air flow conduit 78. In an example, the first passageway 604 may extend between an intake opening 606 and an output opening 610. For example, cooler intake air, represented by arrow 608, enters the first passageway 604 through the intake opening 606, and heated air, represented by arrow 334, exits the first passageway 604 through the output opening 610.

The first heater core 502 may further include a second passageway 612 that extends through the first passageway 604. The second passageway 612 is isolated from the first passageway 604 for directing combustion gases, represented by arrow 614, without mixing the combustion gases 604 with the heated airflow 334. In another embodiment, the outer housing 602 of the first heater core 502 is arranged in fluid connection with the air flow conduit 78 to provide the heated air. In an example, the outer housing of each of the one or more heater cores may be fluidly connected to the air flow conduit 78 for delivering heated air to the enclosure 100.

In an embodiment, the first heater core 502 comprises a fuel nozzle 622 located in the outer housing 602. The fuel nozzle 622 may be located in the second passageway 612, such that the fuel nozzle 622 is isolated from the first passageway 604 for directing combustion gases. In an example, the second passageway 612 is in fluid communication with a combustion air intake 616 and a combustion exhaust 618. Further, an exhaust conduit 620 may be connected to the combustion exhaust 618 so that the exhaust conduit 620 may direct the combustion gases 614 away from or into the pressurized supply air coming from the fan 70. In another example, the fuel nozzle 622 may be located in the outer housing 602, and particularly, within the second passageway 612, isolated from the first passageway 604. The fuel nozzle 622 may be connected to a fuel supply 626 (e.g., an electric fuel pump) through a fuel inlet 628. An ignition device 624 may be provided in the first heater core 504. The ignition device 624 may be configured to ignite the fuel provided in the second passageway 612 by the fuel nozzle 622 while supply air is supplied from an air source 632 (e.g., an air blower) to the second passageway 612 through the combustion air intake 616.

In another embodiment, the ignition device 624 may be configured to ignite the fuel for heat generation. The ignition device 624 is provided in the second passageway 612 proximal to the fuel nozzle 622. In an example, heat may be produced from a flame by igniting atomized fuel spray from the fuel nozzle 622 along with a spark from a spark plug 630 that is part of the ignition device 624. For example, electricity may be supplied to the ignition device 624 using any suitable power source, such as from a power grid, electric generator or with batteries. The heat provided by the flame is transferred to the intake air 608 thereby providing heated air that exits through the output opening 610. Electric current may be provided for ignition to the spark plug by the ignition device 622, e.g., which may convert a voltage (e.g., 12 or 24 volts) to a high voltage, oscillating current, which may be used to provide a continuous spark and ignite a continuous burning process. The outer housing 602 separates the heated air 608 from the air from the fan 70 by passing the first heater core 502 until the heated air 608 exits the first passageway 604 through the outlet opening 610 where the two streams of air may mix thereby heating the temperature of the cooler intake air 608.

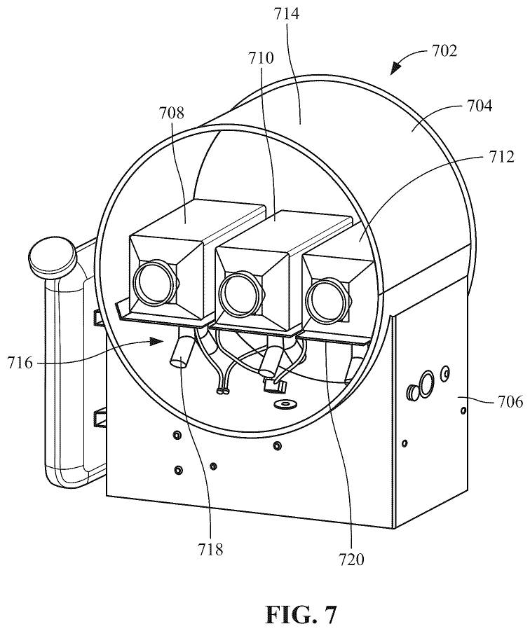

FIG. 7 illustrates an example combustion-type heater 702, according to one or more example embodiments of the present disclosure. In an example, the combustion-type heater 702 includes an air flow conduit 704 (e.g., a section of a metal tube) that is mounted above the ground using a support base 706. For example, the combustion-type heater 702 may be an embodiment of the combustion-type heater 402. Moreover, the air flow conduit 704 may be an embodiment of the air flow conduit 78. The combustion-type heater 702 further includes one or more heater cores, such as a first heater core 708, a second heater core 710, and a third heater core 712. For example, the first heater core 708, the second heater core 710, and the third heater core 712 may be embodiments of the first heater core 502 and/or the second heater core 504. The first heater core 708, the second heater core 710, and the third heater core 712 may be mounted inside the air flow conduit 704 and spaced radially from a sidewall 714 of the air flow conduit 704.

Similar to or the same as the first heater core 502 described above, the one or more heater cores, such as the first heater core 708, the second heater core 710, or the third heater core 712 are configured to provide heated air inside the air flow conduit 704, which receives pressurized supply air from the fan 70. In particular, each of the first heater core 708, the second heater core 710, and the third heater core 712 are mounted on raised platform structures 716 that each include a base 718 and a platform 720 that is mounted upon the base 718. Each of the first heater core 708, the second heater core 710, and the third heater core 712 are mounted on a respective platform 720. While three platforms 720 are shown, there may be less than three platforms 720, such as one platform 720 or more than three platforms 720. The combustion-type heater 702 may comprise the one or more heaters cores. A number of the one or more heater cores may depend on an amount of heat desired, desired heating conditions, a size of the enclosure 100, and the weather conditions. The exhaust of the one or more heater cores during operation may be vented outside the air flow conduit 704.

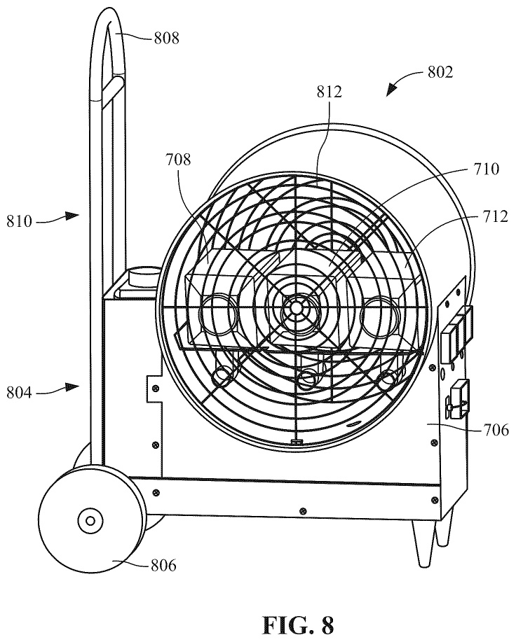

FIG. 8 illustrates an example combustion-type heater 802, according to one or more example embodiments of the present disclosure. For example, the combustion-type heater 802 may be an embodiment of the combustion-type heater 402 or the combustion-type heater 702. In an embodiment, the combustion-type heater 802 is mounted to a wheeled movable chassis (also referred to as a cart, hereinafter) to move the combustion-type heater 802 along a surface. In an example, a combustion-type heater 802, the support base 706 that supports the air flow conduit 704 may be part of a cart body 804 of a cart 810 having wheels 806 and may include a handle 808 forming a portable type of the combustion-type heater 802. A user input 808 may be provided, for example, on the support base 706, that may be used to control an operation of the first heater core 708, the second heater core 710, and the third heater core 712 of the combustion-type heater 802. A protective screen 812 may be provided that may cover opposite sides 810 of the air flow conduit 704.

In the above embodiment, the first heater core 708, the second heater core 710, and the third heater core 712 of the combustion-type heater 802 are oriented axially; however, any suitable orientation may be used for the heater cores.

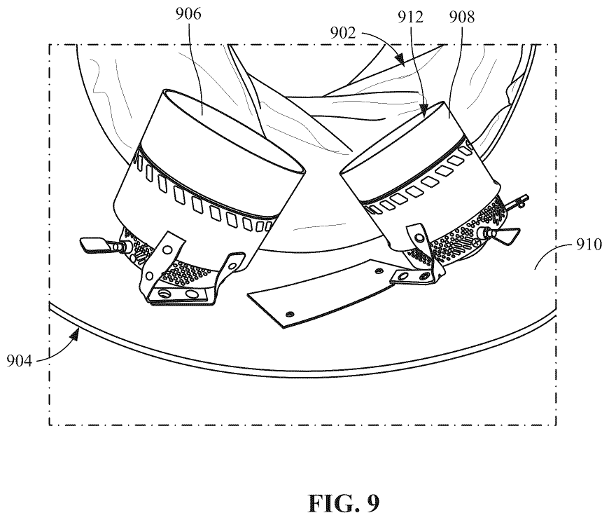

FIG. 9 illustrates an example combustion-type heater 902, according to one or more example embodiments of the present disclosure. For example, the combustion-type heater 902 may be an embodiment of the combustion-type heater 402, the combustion-type heater 702, or the combustion-type heater 802. In an embodiment, the combustion-type heater 902 includes a heater core 906 and a heater core 908 that are mounted directly to a sidewall 910 of an air flow conduit 904. For example, the air flow conduit 904 may be an embodiment of the air flow conduit 78 or the air flow conduit 704; and the heater core 906 and the heater core 908 may be embodiments of the first heater core 502, the second heater core 504, the first heater core 708, the second heater core 710, and/or the third heater core 712.

According to an example embodiment, the heater cores 906 and 908 may be of a different type than the first heater core 708, the second heater core 710, and the third heater core 712, but still be the combustion-type heaters. For example, the heater core 906 and the heater core 908 may be propane-type or other suitable gas heaters that extend through openings in the sidewall 910, so that the heater cores 906 and 908 may be connected to a fuel source. Heat may be provided though outlet openings 912. In this regard, the heater cores 906 and 908 may be oriented radially.

### C. Preparing the Sealant Injection Stations

Referring again to FIG. 1A, a battery for each of the sealant injection stations 30 desired to be used in the enclosure 100 should be sufficiently charged to operate the sensors, pump assembly, and a network card for communicating with the main control unit 20 and other sealant injection stations through a local mesh network. A container 150 of sealant material is positioned within housing 140. The nozzles 170 are positioned as desired. The sealant material and the nozzles 170 are placed in functional arrangement with the delivery system 160, such that during operation, the liquid sealant material is delivered from the sealant container 150 to the nozzle 170. A compressed air line 200 is placed in functional arrangement with each nozzle 170, such that during the operation, the compressed air interacts with the liquid sealant material to create a fog of aerosolized sealant particles as described above.

### D. Pre-Sealing Operation

The main control unit 20 is powered up, either using a generator or in-house power source. The user interface device 40 is powered up and an operator may verify that each of the sealant injection stations 30 are able to send and receive signals and a check may be made of the sensor readings. The fan 70 is used to create a pressure differential in the enclosure 100 as measured by the manometer 220. Initial conditions in the enclosure 100, such as a measure of the leakage in the enclosure is determined.

### E. Sealing Operation

FIG. 1B illustrates a detailed view of a leak site of the enclosure, according to one or more example embodiments of the present disclosure. At each of the sealant injection stations 30, the delivery system 160, responsive to control, delivers sealant material to the nozzles 170 where it is met with compressed air to aerosolize and dry the sealant material. The sealant particles are carried by the air toward leak sites 190 where the sealant particles 250 (as shown in FIG. 1B) adhere to the edges of the leaks site(s) and to each other to form an air barrier. If the humidity sensor 178 at any of the sealant injection stations, such as a sealant injection station 30a, senses a local humidity at the predetermined threshold (e.g., setpoint or range), the delivery system 160 will automatically shut off. The system 10 thus uses feedback from the humidity sensor 178 to determine that the sealant injection stations 30a has imparted sufficient sealant to the local area.

Another sealant injection stations 30, for example, a sealant injection station 30b, operates autonomously from the sealant injection stations 30a, and may continue to deliver sealant material to its local area until a humidity in the corresponding local area reaches the predetermined threshold. Progress of the overall sealing of the enclosure 100 is monitored and controlled until a desired level of air sealing is attained.

### F. Post Seal

In some embodiments, the system 10 is configured to run a post-seal analysis of the air leakage in the enclosure 100 and may provide a certificate of results of the sealing operation. In one embodiment, data from the sealing operation may be stored on the main control unit 20 and/or uploaded to a remote location. In one embodiment, system 10 is configured to automatically upload data about a sealing event upon completion.

In some embodiments, a total amount of sealant ejected by, for example, the sealant injection station 30a may be compared with a total amount of sealant ejected by, for example, the sealant injection station 30b to determine where each of the sealant injection stations 30 might be optimally placed. For example, each of the sealant injection stations 30 may eject different amounts of sealant fluid and thus, it may be desirable to position the sealant injection stations 30 in a similar application (e.g., another enclosure with a similar floorplan), so as to shorten the time required for the sealing process. For example, if the sealant injection station 30a ejected significantly less sealant than the sealant injection station 30b, then in a subsequent sealing event, the sealant injection station 30a may be positioned closer to the sealant injection station 30b or positioned such that a local area of the sealant injection station 30a is significantly smaller than a local area of the sealant injection station 30b. This is just one example of how information from each discrete sealant injection stations 30 may be utilized to optimize the sealing events.

The above-described system 10 includes a plurality of modular, autonomously operable stations, where each modular station has a sensor able to monitor and control an output of material from the station responsive to a sensed condition. Each modular station may be configured to communicate with any other modular station as well as a main control unit.

The systems 10 includes at least one modular station enabled to operate in spatial relationship to a main control unit via wireless connectivity. The modular station includes a housing configured to hold a container of material to be ejected, such as sealant material, at least one nozzle assembly, means to deliver the material from the container to the nozzle assembly, and a sensor able to sense a local environmental condition whereby the means to deliver the material operates based on the sensed local environmental condition.

The system 10 may be configured such that a number of the modular stations that may be used to air seal the enclosure 100 is based on a square footage of the enclosure 100 (and/or total leakage of the enclosure) and may be scalable to accommodate enclosures with a large square footage.

The system 10 may be configured such that each modular station provides closed loop concentration control (e.g., humidity control) for water-based sealant particle size formation. Closed-loop control means that flow rate of the sealant injection stations 30 is determined based on measured concentration, which may be performed by each sealing station with its own closed-loop control sensors, calculations and actuation, using any number of sealant injection stations. One embodiment may have the sealant injection stations do their own calculations, whereas another embodiment may have the calculations performed by the main control unit 20. The preferred embodiment has the closed-loop control calculations performed locally at each sealing station.

The system 10 may be configured to control sealant flow rate based on calculated concentration determined by the local humidity. While each of the independent sealant injection stations provide closed-loop control, the information from each of the one or more sealant injection stations contributes to system-wide open loop control. For example, an open loop check may be made on operation and connectivity of each sealing station while each independent sealing station operates with closed-loop control, or an open-loop check on the total amount of sealant transfer by the full collection of sealant injection stations, thereby flagging independent control faults. Thus, the overall sealing process for an enclosure 100 may be monitored and controlled, and the local region at each of the one or more sealant injection stations is monitored and controlled.

The system 10 may be configured such that each modular station is independently operable to control local humidity which in turn may affect sealant particle size.

The principles contained herein may be used to control a concentration of any vapor or gas using closed loop control using a sensed environmental condition.

The system 10 may be configured such that the drying process for the sealant/solvent mixture may be controlled by controlling a concentration of the sealant or other material in the environment. For water, the humidity may be measured. Other solvent parameters may be measured and/or controlled.

The system 10 may be configured so that each sealing station may measure one or more environmental conditions (e.g., humidity, pressure) to monitor the progress of sealing at each discrete location and provide information related to the overall sealing event. For example, the sealant injection stations 30 may be located in different areas of branched ductwork. Pressure distribution analysis at the site of each of sealant injection stations 30 and across the entire enclosure 10 during sealing may be used.

In one embodiment, post-sealing or real-time analysis of the relative amount of sealant transfer by each of the one or more sealant injection stations 30 may be used to optimize the locations of sealant injection stations. For example, if one sealing station is sealant injection stations 30 little or no sealant that station should be moved to a location at or near other sealant injection stations that are sealant injection stations 30 much more sealant, as there is a greater need in locations that are calling for more sealant injection stations 30.

In some embodiments, remote stations may measure absolute or differential pressure at each location to give indication of where sealing is occurring, for example sealant injection stations in different areas of branched duct systems.

In some embodiments, sensed humidity may be used to indicate where sealing is occurring. Some embodiments include a combustion-type heater 130 selection algorithm to facilitate the maximum addition of heat to a system so as to facilitate the maximum flow rate of sealant, choosing the heat level so as to not drive the relative humidity too low and risking the deposition of overly dry sealant in the leakage. The upper limit on the amount of heat that may be added is determined by the maximum sealant injection stations 30 rate that the installed number of sealant injection stations may produce. At one end of spectrum (e.g. on a cold humid day), the algorithm will turn on all combustion-type heater(s) 130, to maximize a rate of the sealant injection stations 30. At the other end of the spectrum (e.g. a hot, dry day), the algorithm will turn on fewer, and potentially no combustion-type heater(s) 130, to avoid a low indoor relative humidity caused by inadequate sealant/water sealant injection stations 30 capacity. The algorithm does this by examining the possibility of adding heat to the system, starting with the highest possible level of added heat and then examining the indoor humidity produced, based upon the temperature and relative humidity of the outside air being blown into the enclosure, and the flow rate of the outside air being blown into the enclosure. If the indoor relative humidity under those conditions is lower than the target value, the control algorithm will lower the level of added heat to the next lower level, repeating this process until either the target humidity level is predicted to be achieved, or it potentially reaches the lowest level of no added heat at all. If the algorithm lands at no added heat, it suggests adding additional sealant injection stations, or alternately, adding straight humidification.

In some embodiment, the combustion-type heater 130 may include an integrated fuel tank for supplying the fuel to the one or more heater cores. For example, the combustion-type heater includes a built-in fuel tank responsible for supplying fuel to one or more heater cores. These heater cores are the components where combustion occurs, generating heat. By integrating the fuel tank, the system 10 ensures a streamlined and efficient fuel supply process, eliminating the need for external fuel sources.

In another embodiment, the combustion-type heater 130 may an integrated auto-stop function configured to cut off a supply of the heated air in response to a determination of an enclosure temperature to exceed a predefined temperature threshold. For example, the system 10 is equipped with an intelligent auto-stop mechanism. When the system 10 detects that the enclosure temperature surpasses a predefined threshold, it promptly cuts off the supply of heated air. This safety feature prevents overheating and potential damage to the enclosure or its contents. Essentially, it acts as a protective measure, ensuring that the combustion-type heater 130 doesn't operate beyond safe limits.

Use of non-electric, combustion-type heater 130 may break dependence on large, centralized generators, which may require a trailer or other large transport vehicle to transport. The use of combustion-type heaters 130 may also provide an effective heating product when operating in colder outdoor climates. The primary source of fuel for heat generation may be diesel, propane, butane, etc. The combustion type heater 130 may have an integrated auto-stop function to cut off the supply of heat in case the temperature exceeds a prescribed value. The heater modules may be configured to be handled and installed by a single person.

In some embodiments, a main control unit communicates to the remote sealant injection stations 30 and/or measurement stations through a computer network, such as a wireless mesh network. In some embodiments, the remote devices consist of sealant injection stations 30, but other types of remote devices are possible, including sensor packs for measuring temperature and humidity, sensor packs for measuring compressed air or sealant pressure, and fan controllers combined with manometers for providing remote control of booster fans. The communications consist of sensor readings coming from remote devices, and actuation commands being sent out to the remote devices. The main control unit 20 may send a request to any remote device to send a regular heartbeat communication to allow the main control unit to judge when a remote device has gone out of communication.

The main actuation commands for the sealing station type of remote devices are the commands to begin sealing and to stop sealing. The command to begin sealing includes a range of desired relative humidity. The sealant injection stations 30 will dispense sealant until the local relative humidity reaches the upper limit of the range and the turn off until the lower range of humidity is reached. This may be achieved either by variable speed sealant injection stations 30, duty cycling of constant speed sealant injection stations 30, or on-off control of constant or variable-speed sealant injection stations 30 based upon a dead-band, with or without anticipation.

In some embodiments, a failsafe prevents any sealing station from dispensing sealant continuously without reporting back to the main control unit. The command to dispense sealant is time limited to a given number of seconds. As the sealant injection stations 30 is nearing the end of the sealant dispensing time, the sealant injection stations send a countdown to the main control unit to inform it that sealing time is running out. If sealing is still in progress, the main control unit may then send a new command to dispense sealing to ensure uninterrupted sealing. If the sealing station does not get a new command to continue sealing, the sealant injection station will stop dispensing sealant automatically.

Once the operator has sent the command to begin dispensing sealant to the sealant injection stations 30 through the main control unit, the sealant injection stations 30 will continue dispensing sealant until a command to stop is sent through the network, the sealing station's battery charge becomes too low, or the sealant injection station 30 loses communication with the main control unit for some predefined time period. In a dead-band control embodiment, the sealant injection stations 30 temporarily stopped as needed when the ambient humidity exceeds or approaches the upper limit of the requested range.

Embodiments disclosed herein may include some or all of the elements of one or more of the clauses below.

Clause 1: An aerosolized sealant particle injection system comprising: one or more sealant injection stations comprising: one or more sealant injection stations comprising: a supply reservoir to store a fluid and a sealant; and a sprayer assembly to aerosolize the fluid and the sealant within an enclosure, wherein the enclosure comprises at least one leak opening; and a combustion-type heater to generate heat for heating the enclosure, such that during an operation, the heating of the enclosure causes solidification of aerosolized particles of the fluid and the sealant in the enclosure to seal the at least one leak opening.

Clause 2: The system of clause 1, wherein the combustion-type heater comprises an air flow conduit to supply heated air to the enclosure; and one or more heater cores configured to provide the heated air to the air flow conduit.

Clause 3: The system of clause 2, wherein each of the one or more heater cores comprises at least one of: an outer housing having a first passageway for directing the heated air into the air flow conduit; a fuel nozzle located in the outer housing, the fuel nozzle located in a second passageway isolated from the first passageway for directing combustion gases, the second passageway being in fluid communication with a combustion air intake and a combustion exhaust; and an ignition device configured to ignite a fuel for heat generation, wherein the ignition device is provided in the second passageway by the fuel nozzle.

Clause 4: The system of clause 3 wherein the outer housing of each of the one or more heater cores is arranged in fluid connection with the airflow conduit to provide the heated air.

Clause 5: The system of clause 3, wherein each of the one or more heater cores are arranged outside the air flow conduit such that the one or more heater cores are in fluid communication with an interior of the air flow conduit using an air duct to provide the heated air, wherein the combustion air intake and the combustion exhaust is isolated from the heated air.

Clause 6: The system of clause 3, wherein the air duct is connected to a vent located inside the air flow conduit.

Clause 7: The system of clause 2, wherein the one or more heater cores are arranged inside the air flow conduit.

Clause 8: The system of clause 2, wherein the air flow conduit is fluidly connected to a tubing that extends towards the enclosure.

Clause 9: The system of clause 8, wherein the tubing is connected to a fan to provide feed air, wherein the one or more heater cores are operable to heat the feed air to produce the heated air.

Clause 10: The system of clause 2, wherein the air flow conduit of the combustion-type heater is located between a fan and the tubing that extends toward the enclosure.

Clause 11: The system of clause 2, wherein the combustion-type heater is mounted to a wheeled movable chassis to move the combustion-type heater along a surface

Clause 12: The system of clause 1, wherein the combustion type heater comprises an integrated fuel tank for supplying the fuel to the one or more heater cores; and an integrated auto-stop function configured to cut off a supply of the heated air in response to a determination of an enclosure temperature to exceed a predefined temperature threshold.

Clause 13: The system of clause 1, wherein the system further comprises a delivery system to transfer the sealant and the fluid to the sprayer assembly.

Clause 14: A method of providing heat to an enclosure for sealing the enclosure using an aerosolized sealant particle injection system. The aerosolized sealant particle injection system comprises one or more sealant injection stations and a combustion-type heater to generate heat for heating the enclosure, the one or more sealant injection stations comprising a supply reservoir to store a fluid and a sealant, and a sprayer assembly. The method comprises aerosolizing, using the sprayer assembly, the fluid and the sealant within the enclosure. The enclosure comprises at least one leak opening. The method further comprises generating heat for the enclosure from the combustion-type heater. The method further comprises heating the enclosure using the heat. The heating causes solidification of aerosolized particles of the fluid and the sealant in the enclosure to seal the at least one leak opening.

Clause 15: The method of clause 14 wherein the combustion-type heater comprises an air flow conduit to supply heated air to the enclosure, and one or more heater cores configured to provide the heated air to the air flow conduit.

Clause 16: The method of clause 15, wherein the one or more heater cores comprises at least one of: an outer housing having a first passageway for directing the heated air into the air flow conduit; a fuel nozzle located in the outer housing, the fuel nozzle located in a second passageway isolated from the first passageway for directing combustion gases, the second passageway being in fluid communication with a combustion air intake and a combustion exhaust; and an ignition device configured to ignite a fuel for heat generation, wherein the ignition device is provided in the second passageway by the fuel nozzle.

Clause 17: The method of clause 16, the outer housing of each of the one or more heater cores is arranged in fluid connection with the airflow conduit to provide the heated air.

Clause 18: The method of clause 16, wherein each of the one or more heater cores are arranged outside the air flow conduit such that the one or more heater cores are in fluid communication with an interior of the air flow conduit using an air duct to provide the heated air, wherein the combustion air intake and the combustion exhaust is isolated from the heated air.

Clause 19: The method of clause 16, wherein the air flow conduit is fluidly connected to a tubing that extends towards the enclosure.

Clause 20: The method of clause 19, wherein the tubing is connected to a fan to provide feed air, wherein the one or more heater cores are operable to heat the feed air to produce the heated air.

While embodiments are described with relation to delivering a sealant material to form an air barrier for an enclosure, it is envisioned that the concept of using a humidity or other sensed condition to determine and control an amount of aerosolized material being delivered may be applied to other situations as well, such as, for example, controlling an amount of odorant used to enhance ambient conditions in a retail setting.

It is noted that the terms “substantially” and/or “about” may be utilized herein to represent the inherent degree of uncertainty that may be attributed to any quantitative comparison, value, measurement, or other representation. These terms are also utilized herein to represent the degree to which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An aerosolized sealant particle injection system comprising:
one or more sealant injection stations comprising:
a supply reservoir to store a fluid and a sealant, and
a sprayer assembly to aerosolize the fluid and the sealant within an enclosure, wherein the enclosure comprises at least one leak opening; and
a combustion-type heater to generate heat for heating the enclosure, such that during an operation, the heating of the enclosure causes solidification of aerosolized particles of the fluid and the sealant in the enclosure to seal the at least one leak opening.

2. The system of claim 1, wherein the combustion-type heater further comprises:
an air flow conduit to supply heated air to the enclosure; and
one or more heater cores configured to provide the heated air to the air flow conduit.

3. The system of claim 2, wherein each of the one or more heater cores comprises at least one of:
an outer housing having a first passageway for directing the heated air into the air flow conduit;
a fuel nozzle located in the outer housing, the fuel nozzle located in a second passageway isolated from the first passageway for directing combustion gases, the second passageway being in fluid communication with a combustion air intake and a combustion exhaust; and
an ignition device configured to ignite a fuel for heat generation, wherein the ignition device is provided in the second passageway by the fuel nozzle.

4. The system of claim 3, wherein the outer housing of each of the one or more heater cores is arranged in fluid connection with the air flow conduit to provide the heated air.

5. The system of claim 3, wherein each of the one or more heater cores are arranged outside the air flow conduit such that the one or more heater cores are in fluid communication with an interior of the air flow conduit using an air duct to provide the heated air, wherein the combustion air intake and the combustion exhaust is isolated from the heated air.

6. The system of claim 5, wherein the air duct is connected to a vent located inside the air flow conduit.

7. The system of claim 2, wherein the one or more heater cores are arranged inside the air flow conduit.

8. The system of claim 2, wherein the air flow conduit is fluidly connected to a tubing that extends towards the enclosure.

9. The system of claim 8, wherein the tubing is connected to a fan to provide feed air, wherein the one or more heater cores are operable to heat the feed air to produce the heated air.

10. The system of claim 2, wherein the air flow conduit of the combustion-type heater is located between a fan and the tubing that extends toward the enclosure.

11. The system of claim 1, wherein the combustion-type heater is mounted to a wheeled movable chassis to move the combustion-type heater along a surface.

12. The system of claim 1, wherein the combustion type heater further comprises
an integrated fuel tank for supplying the fuel to the one or more heater cores; and
an integrated auto-stop function configured to cut off a supply of the heated air in response to a determination of an enclosure temperature to exceed a predefined temperature threshold.

13. The system of claim 1, further comprising a delivery system to transfer the sealant and the fluid to the sprayer assembly.

14. A method of providing heat to an enclosure for sealing the enclosure using an aerosolized sealant particle injection system, wherein the aerosolized sealant particle injection system comprises one or more sealant injection stations and a combustion-type heater to generate heat for heating the enclosure, the one or more sealant injection stations comprising a supply reservoir to store a fluid and a sealant, and a sprayer assembly, and wherein the method comprises:
aerosolizing, using the sprayer assembly, the fluid and the sealant within the enclosure, wherein the enclosure comprises at least one leak opening;
generating heat for the enclosure from the combustion-type heater; and
heating the enclosure using the heat, wherein the heating causes solidification of aerosolized particles of the fluid and the sealant in the enclosure to seal the at least one leak opening.

15. The method of claim 14, wherein the combustion-type heater comprises an air flow conduit to supply heated air to the enclosure, and one or more heater cores configured to provide the heated air to the air flow conduit.

16. The method of claim 15, wherein the one or more heater cores comprises at least one of:
an outer housing having a first passageway for directing the heated air into the air flow conduit;
a fuel nozzle located in the outer housing, the fuel nozzle located in a second passageway isolated from the first passageway for directing combustion gases, the second passageway being in fluid communication with a combustion air intake and a combustion exhaust; and
an ignition device configured to ignite a fuel for heat generation, wherein the ignition device is provided in the second passageway by the fuel nozzle.

17. The method of claim 16, wherein the outer housing of each of the one or more heater cores is arranged in fluid connection with the air flow conduit to provide the heated air.

18. The method of claim 16, wherein each of the one or more heater cores are arranged outside the air flow conduit such that the one or more heater cores are in fluid communication with an interior of the air flow conduit using an air duct to provide the heated air, wherein the combustion air intake and the combustion exhaust is isolated from the heated air.

19. The method of claim 15, wherein the air flow conduit is fluidly connected to a tubing that extends towards the enclosure.

20. The method of claim 19, wherein the tubing is connected to a fan to provide feed air, wherein the one or more heater cores are operable to heat the feed air to produce the heated air.
